(19) United States
(12) Patent Application Publication
(10) Pub. No.: US 2009/0107181 A1
(43) Pub. Date: Apr. 30, 2009

(54) Preform producing apparatus and molten glass-supporting member

(75) Inventor: Ryousuke Sakai, Kanagawa (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Ohara Inc.

(21) Appl. No.: 12/289,329

(22) Filed: Oct. 24, 2008

(30) Foreign Application Priority Data
Oct. 26, 2007 (JP) 2007-278782
Sep. 18, 2008 (JP) 2008-239041

(51) Int. Cl. C03B 9/00

(52) U.S. Cl. 65/68; 65/361

(57) ABSTRACT

A preform producing apparatus, in which the apparatus is downsized and capable of producing preforms at a lower cost, and a molten glass-supporting member used for the preform producing apparatus are provided. A molten glass-supporting member 1 has an openable and closable receiving member 12, of which a receiving surface 13 for receiving molten glass is constructed from a plurality of members 11a and 11b, and a closed state-maintaining member 14 for maintaining the receiving member 12 in a closed state.

This application is based on and claims the benefit of priority from Japanese Patent Application Nos. 2007-278782 and 2008-239041, respectively filed on 26 Oct. 2007 and 18 Sep. 2008, the content of which is incorporated herein by reference.

### BACKGROUND OF THE INVENTION

1. Field of the Invention

The present invention relates to a preform producing apparatus for producing preforms from molten glass in a step of producing an optical element, for example, and to an openable and closable molten glass-supporting member used in the preform producing apparatus.

2. Related Art

In recent years, optical lenses shaped into a predetermined shape have been used for optical elements such as lenses of digital cameras. A publicly known method to mass-produce the optical lenses with high precision is, for example, as follows. That is, initially, a glass body having a shape approximate to that of the optical lens (hereinafter referred to as “preform”) is formed using molten glass, and then the preform is hot-worked with a mold.

This method provides advantages such as lead time can be shortened, yield decrease due to defective processing can be suppressed, and consequently cost can be significantly saved, since optical lenses are shaped through a preform from molten glass, compared to the methods of producing optical lenses from plate glass through multiple steps such as cutting, processing, press, grinding and polishing.

The preform producing apparatus for producing preforms described above is exemplified by one that includes a flow-down device for flowing down molten glass from a tip of a nozzle, a lower mold disposed at a lower side of the flow-down device for receiving the flowed down molten glass, and an upper mold to engage with the lower mold (see Patent Document 1).

The preform producing apparatus initially flows down the molten glass from the flow-down device into the lower mold. Then, the flowed down molten glass is received by the lower mold to form a molten glass body. Thereafter, the upper mold is engaged with the lower mold to shape the molten glass body, thereby producing a preform.

However, hot molten glass directly contacts with the upper and lower molds in the preform producing apparatus described above. Therefore, these molds, in particular the lower mold, tend to get rough due to surface oxidization, resulting in a lusterless surface of the preform where the shape of mold surface is transferred. It is considered that molds should be exchanged early in order to solve the problem; however, there are problems that operating rates of preform producing apparatuses decrease and production cost increases since exchange of molds is time-consuming.

An apparatus to solve such problems is publicly known in which molten glass is received on a first mold member to shape the molten glass to some extent, then the first mold member is opened to drop the molten glass onto a second mold member, and press molding is performed by the second mold member, for example (see Patent Document 2). Surface oxidization can be suppressed at the surface of molds shaping preforms since molten glass contacts with the second mold after its temperature has decreased to some extent in accordance with this method. However, there is a problem that apparatuses become of large-scale since the mechanism to open and close the first mold member for receiving molten glass makes use of the power of an air cylinder. There is also a problem that operation to meet contacting surfaces requires a lot of skill so as to contact highly precisely opposing surfaces of the members when closing the opened first mold member.

Patent Document 1: Japanese Unexamined Patent Application, First Publication No. Hei 07-165431

Patent Document 2: Japanese Unexamined Patent Application, First Publication No. Hei 06-340430

### SUMMARY OF THE INVENTION

The present invention has been made to solve the abovementioned problems; it is an object of the present invention to provide a preform producing apparatus, in which the apparatus is downsized and can produce preforms with a lower cost, and a molten glass-supporting member used in the preform producing apparatus.

The present inventors have found that the preform producing apparatus can be downsized by way of independently providing an openable and closable molten glass-supporting member and a means for opening and closing the molten glass-supporting member (receiving member-opening means), and the perform can be produced with high precision since the receiving member can be opened and closed without requiring operator skill by virtue of improving contacting conditions between members by use of a closed state-maintaining member, thereby achieving the present invention. More specifically, the present invention provides the following.

In a first aspect of the present invention, a molten glass-supporting member includes an openable and closable receiving member, of which a receiving surface for receiving molten glass is constructed from a plurality of members, and a closed state-maintaining member for maintaining the receiving member in a closed state.

According to a second aspect, the molten glass-supporting member according to the first aspect further includes an outer frame outside the receiving member, and the outer frame is provided with a guide means for defining opening and closing orbits of the receiving member.

According to a third aspect, in the molten glass-supporting member according to the second aspect, the closed state-maintaining member is interposed between the receiving member and the outer frame.

According to a fourth aspect, in the molten glass-supporting member according to the first or second aspect, the closed state-maintaining member is provided inside the receiving member.

According to a fifth aspect, in the molten glass-supporting member according to any one of the first to fourth aspects, the closed state-maintaining member has an elastic body.

According to a sixth aspect, in the molten glass-supporting member according to any one of the first to fourth aspects, the closed state-maintaining member has a permanent magnet or an electromagnet.

According to a seventh aspect, in the molten glass-supporting member according to any one of the first to fourth aspects, the closed state-maintaining member has a portion made of a shape-memory alloy.

According to an eighth aspect, in the molten glass-supporting member according to any one of the first to fourth aspects, the closed state-maintaining member has a combination of at least two selected from the group consisting of an elastic body, a permanent magnet, an electromagnet and a portion made of a shape-memory alloy.

In a ninth aspect, a preform producing apparatus includes a molten glass-supporting member according to any one of the first to eighth aspects,

a discharge nozzle for discharging molten glass onto the receiving surface,

a transfer means for transferring the molten glass-supporting member, and

a receiving member-opening means for opening the receiving member of the molten glass-supporting member transferred by the transfer means.

In a tenth aspect, a preform producing apparatus includes a molten glass-supporting member according to any one of the first to eighth aspects,

a discharge nozzle for discharging molten glass onto the receiving surface of the receiving member under a closed state,

a transfer means for transferring the molten glass-supporting member, and

a receiving member-opening means for opening the receiving member of the molten glass-supporting member transferred by the transfer means.

According to an eleventh aspect, in the preform producing apparatus according to the tenth aspect, the molten glass discharged from the discharge nozzle is received by the receiving surface, then the transfer means transfers the receiving member-opening means to below the receiving member-opening means, and the receiving member-opening means pushes open the receiving member, thereby making the molten glass on the receiving member drop down.

According to a twelfth aspect, in the preform producing apparatus according to the tenth or eleventh aspect, the molten glass discharged from the discharge nozzle is molded, while increasing viscosity of the molten glass, on the molten glass-supporting member, and logη is no less than 1.0 at the time when the molten glass is dropped down from the receiving member (η: viscosity of molten glass expressed by dPa·s, log: logarithm).

According to a thirteenth aspect, in the preform producing apparatus according to any one of the tenth to twelfth aspects, logη is less than 1.0 at the time when the molten glass is discharged from the discharge nozzle (η: viscosity of molten glass expressed by dPa·s, log: logarithm).

According to a fourteenth aspect, in the preform producing apparatus according to any one of the tenth to thirteenth aspects, a mold is provided below the receiving member-opening means, and the molten glass dropped down by way of opening the receiving member is received by the mold.

According to a fifteenth aspect, in the preform producing apparatus according to any one of the tenth to fourteenth aspects, the receiving member-opening means has a taper-shaped tip portion that faces the receiving member.

According to a sixteenth aspect, in the preform producing apparatus according to any one of the tenth to fifteenth aspects, the transfer means transfers the molten glass-supporting member linearly and/or annularly.

According to a seventeenth aspect, in the preform producing apparatus according to any one of the tenth to sixteenth aspects, the closed state-maintaining member has a permanent magnet or an electromagnet, and a tip portion facing the receiving member, in the receiving member-opening means, has a permanent magnet or an electromagnet.

According to an eighteenth aspect, in the preform producing apparatus according to any one of the tenth to seventeenth aspects, the receiving member comes to a close contact state by way of the receiving member performing a closing motion by action of a restoring force of the closed state-maintaining member after opening the receiving member by the receiving member-opening means.

In a nineteenth aspect of the present invention, a method of producing a preform uses the preform producing apparatus according to any one of the tenth to eighteenth aspects.

In accordance with the present invention, the receiving member performs a closing motion from an opened state to a closed state by use of a restoring force of the closed state-maintaining member, which is provided at the molten glass-supporting member itself, and therefore a connecting mechanism to transmit a cylinder power, etc. to the molten glass-supporting member is not always necessary for the purpose of opening or closing the receiving member. Consequently, the design of the preform producing apparatus achieves a higher freedom, and thus the apparatus can be downsized. In addition, a close contact state of the receiving member can be improved by use of the closed state-maintaining member, and therefore the receiving member can be opened and closed with high precision without requiring skillful operators, whereby performs of high precision can be produced.

### BRIEF DESCRIPTION OF THE DRAWINGS

FIG. 1 shows a molten glass-supporting member of a first embodiment of the invention;

FIG. 2 shows a molten glass-supporting member of a second embodiment of the invention;

FIG. 3 shows a molten glass-supporting member of a third embodiment of the invention;

FIG. 4 shows a molten glass-supporting member of a modified example of the abovementioned embodiment;

FIG. 5A shows a molten glass-supporting member of a fourth embodiment of the invention;

FIG. 5B shows a molten glass-supporting member of a fourth embodiment of the invention;

FIG. 6 schematically shows a preform producing apparatus that includes a molten glass-supporting member;

FIG. 7A shows a state in which a receiving member in a closed state turns into an opened state by action of a receiving member-opening means; and

FIG. 7B shows a state in which a receiving member in a closed state turns into an opened state by action of a receiving member-opening means.

### DETAILED DESCRIPTION OF THE INVENTION

The molten glass-supporting member of the invention has an openable and closable receiving member, of which a receiving surface for receiving molten glass is constructed from a plurality of members, and a closed state-maintaining member for maintaining the receiving member under a closed state.

The preform producing apparatus of the invention has the abovementioned molten glass-supporting member, a discharge nozzle for discharging molten glass, a transfer means for transferring the molten glass-supporting member, and a receiving member-opening means for opening the receiving member transferred from the transfer means.

The molten glass-supporting member and the preform producing apparatus of the invention are explained specifically with respect to embodiments thereof in the following; however, the invention should not be limited to the embodiments below and can be carried out with appropriate modifications within the scope of the purpose of the invention. Explanations are appropriately omitted where the explanations are duplicate, but which does not limit the object of the invention.

The term “closed state” in this specification refers to a state in which molten glass is laid on a receiving surface and the molten glass cannot fall down the receiving surface. In addition, the term “opened state” refers to a state in which molten glass cannot be placed on a receiving surface and the molten glass falls down beneath the receiving surface.

### Molten Glass-Supporting Member

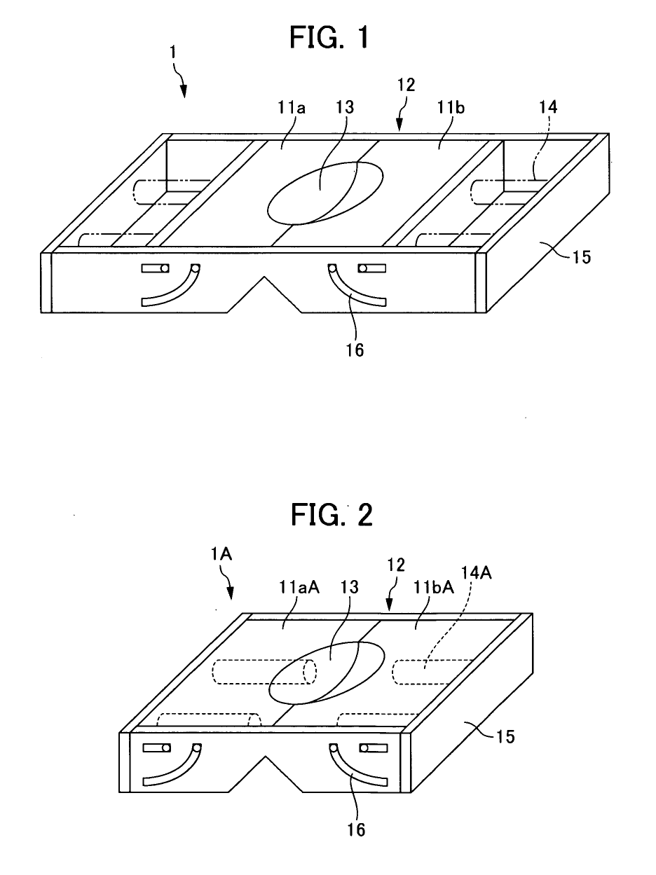

FIG. 1 schematically shows a molten glass-supporting member 1 of the invention. The molten glass-supporting member 1 has a receiving surface 13, and the receiving surface 13 in this embodiment is separated at the center into two members 11a and 11b. That is, the receiving member 12 formed of two members 11a and 11b is openable and closable; when the receiving member 12 becomes in an opened state, the receiving surface 13 for receiving and shaping molten glass is separated into a part of the member 11a and a part of the member 11b. In addition, FIG. 1 shows a case where the receiving member is formed of two members in which, for convenience of explanation, a receiving member formed of more than two members is not excluded.

An outer frame 15 and a guide means 16 for defining opening and closing orbits of the receiving member 12 are provided outside the receiving member 12 (members 11a and 11b). The outer frame 15 is made of refractory metal, stainless steel, or the like.

The guide means 16 is not specifically limited with respect to its shape, etc. as long as it is capable of maintaining constant the opening and closing orbits of the receiving member 12 so that molten glass on the receiving surface 13 can effectively fall down. A conventional guide means can be utilized such as slide rails, guide rails, holes and grooves. However, the guide means is preferably a hole or groove directly processed at the outer frame 15 in view of productivity and simplicity. FIG. 1 shows an example in which the outer frame 15 is provided with holes having an orbital shape of the receiving member 12, and the outer frame 15 and the guide means 16 are integrally constructed.

Furthermore, as shown in FIG. 1, the closed state-maintaining member 14 for maintaining the openable and closable receiving member 12 under a closed state is interposed between the receiving member 12 (members 11a and 11b) and the outer frame 15, and thus the receiving member 12 maintains the closed state in which the members 11a and 11b closely contact as long as not being subjected to an external force pushing outwardly (pushing force).

The receiving member 12 may be constructed as required from a porous material or non-porous material.

When the receiving member 12 is of a non-porous material, it is preferred that the receiving member 12 is constructed from a material that exhibits poor wettability with molten glass; for example, various conventional materials may be utilized such as carbon materials including graphite, complex materials of nitrides and carbides, and refractory metals having a nitrided surface.

Furthermore, a water-cooled pipe (not shown) may be provided to cool the receiving member 12 inside the members 11a and 11b as required. The water-cooled pipe communicates with a cooling water source through a cooling water-feed pipe and a cooling water-discharge pipe to circulate cooling water.

When the receiving member 12 is of a porous material, the receiving member 12 is formed from a refractory porous material or a porous metal of sintered stainless steel, and numerous fine pores are formed over the entire surface of the receiving member 12. It is also preferred that unnecessary fine pores at an area except for the receiving surface 13 is plugged by applying a coating so that gas leaks are prevented from fine pores. Furthermore, the receiving member 12 (members 11a and 11b) is provided with a gas supply chamber (not shown) to eject gas of the gas supply chamber from pores of the porous material. That is, when gas such as air and inert gases is supplied from the gas supply chamber, the gas blows out from the receiving surface 13 through the numerous fine pores. In this way, molten glass received by the receiving surface 13 is cooled under a condition such as floating from the receiving surface 13, and the viscosity increases.

A coating may be applied to a portion or all of the receiving surface 13 as required in order to improve heat resistance of the receiving member 12 and to prevent fusion of the molten glass. The coating material is not specifically limited, and appropriately selected from materials such as metal, oxide, nitride and carbide films that exhibit poor wettability with the molten glass, sufficient resistance to shaping temperatures, and have easy formability into a film by conventional processes such as sputtering, vapor deposition, and plating processes, while considering species, temperature, and compatibility during formation of a film on the receiving member of the molten glass that the receiving member receives. Gold is exemplified as such a material of metal film as having poor wettability with molten glass and easy formability into a film; the material may be mixed with other components in order to apply a coating with improved heat resistance. Gold alloy may be used that contains at least one element selected from aluminum, silicon, vanadium, chromium, titanium, iron, cobalt, nickel, copper, zinc, germanium, yttrium, zirconium, niobium, molybdenum, ruthenium, lead, silver, tin, hafnium, tungsten and platinum, for example. When a gold alloy is used, it is preferred that the content of gold is at least 5%. In regards to oxide, nitride or carbide described above, for example, oxides, nitrides or carbides are useful that contain at least one element selected from boron, rhodium, aluminum, silicon, vanadium, chromium, titanium, iron, cobalt, nickel, copper, zinc, germanium, yttrium, zirconium, niobium, molybdenum, ruthenium, lead, silver, tin, hafnium, tungsten, and platinum. It is also preferred that the film thickness is no less than 0.1 μm and no more than 5 μm.

The receiving surface 13 is not specifically limited with respect to its shape as long as it is capable of receiving the molten glass; it is preferred to receive effectively the molten glass for the shape to enlarge from lower (surface side) to upper, for example, the shape may be a circular cone or multiangular pyramids such as a triangular or quadrangular pyramid.

The receiving member 12 maintains the closed state such that the members 11a and 11b closely contact by action of the closed state-maintaining member 14 as long as not being subjected to an external pushing force. Even after entering an opened state, a closing motion is performed by a restoring force of the closed state-maintaining member 14 when the external pushing force is released. The restoring force of the closed state-maintaining member 14 acts along a desirable direction by the guide means 16 provided at the outer frame 15, thereby returning the members 11a and 11b into the original close-contact state. The position of the closed state of the receiving member 12 is defined by the guide means 16, thus surface mating can be carried out easily and precisely.

The closed state-maintaining member 14 is not specifically limited with respect to its shape, etc. as long as it is capable of enhancing close contact between members 11a and 11b to maintain the closed state and turning into the closed state by action of the restoring force and closing motion even after entering the opened state; it is preferred that elastic bodies such as of springs and plate springs, magnets such as permanent magnets and electromagnets, or shape-memory alloys are used in view of cost, easy-of-use, etc. Furthermore, as shown in FIG. 2, when the closed state-maintaining member 14 is other than elastic bodies, e.g., magnets, it may be provided inside the members 11a and 11b. When the closed state-maintaining member 14 is provided inside the receiving member 12, the molten glass-supporting member 1 is further downsized. A combination of at least two of an elastic body, a magnet, an electromagnet, a shape-memory alloy, etc. may be used in order to generate a higher closed state-maintaining force depending on the weight or size of the molten glass received from the discharge nozzle 2. The number of the closed state-maintaining members 14 to be set may be properly changed depending on the intended use without particular limitation.

The elastic force or magnetic force of the closed state-maintaining member 14 may be properly changed depending on the members 11a and 11b to construct the receiving surface 13, mass of molten glass received by the receiving surface 13, etc. and the force is not specifically limited as long as it is capable of maintaining a closed state even when the molten glass is present on the receiving surface 13 and causing the receiving member 12 to be in a closed state by action of the restoring force, even after the receiving member 12 enters into an opened state by action of a receiving member-opening member, etc. described later. Furthermore, the shape thereof, etc. may be properly modified depending on the intended use without particular limitation, as long as it is capable of withstanding temperatures of molten glass.

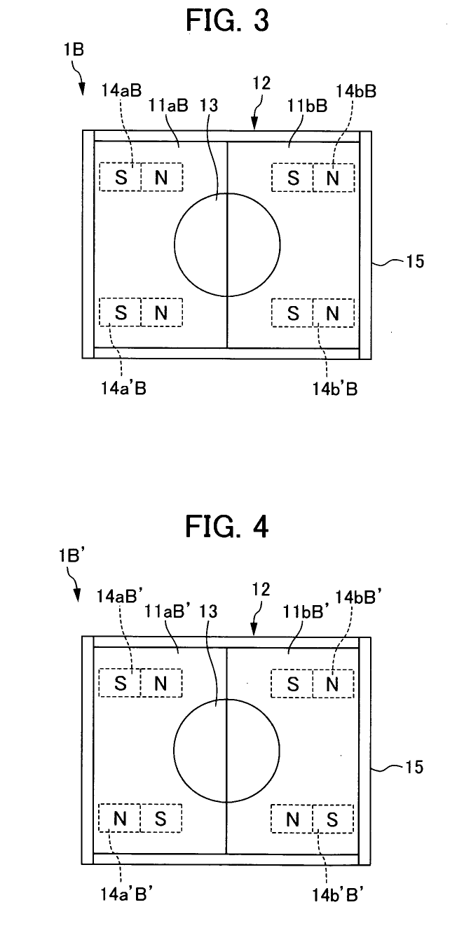

When a permanent magnet is used for the closed state-maintaining member 14, for example, as shown in FIG. 3, the members 11a and 11b closely contact each other in the closed state. It is preferred in this case that each closed state-maintaining member 14 inside the members 11a and 11b is disposed such that portions having a different porosity face each other (for example, the north pole of a closed state-maintaining member 14a B and the south pole of a closed state-maintaining member 14b B face each other). Thus, the members 11a and 11b can maintain a higher close-contact state by action of the magnetic force and the receiving surface 13 can be prevented from generating a space. In this embodiment, closed state-maintaining members 14a B and 14a′B inside the member 11a have poles aligning in the same direction to each other and closed state-maintaining members 14b B and 14b′B in the member 11b also have poles aligning in the same direction to each other, but not as to be limited thereto. That is, as shown in FIG. 4, closed state-maintaining members 14a B′ and 14a′B′ in the member 11a may have poles aligning in the opposite directions to each other and closed state-maintaining members 14b B′ and 14b′B′ in the member 11b also may have poles aligning in the opposite directions to each other. Thus, the members 11a and 11b obtain a higher state of contact. In addition, the closed state-maintaining members shown in FIGS. 3 and 4 may be a separable or integral body; and the members 11a and 11b may form a magnet by themselves.

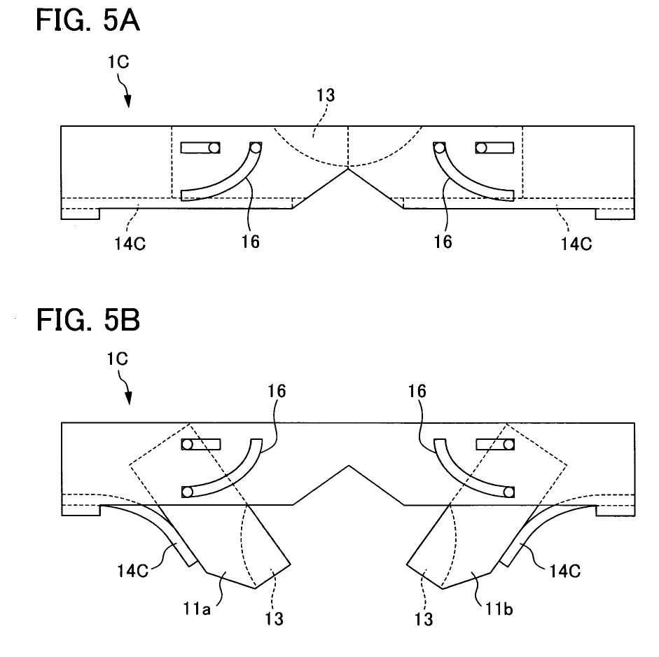

When an elastic body is used for the closed state-maintaining member, for example, an elastic body 14 like a spring can be used as shown in FIG. 1, or an elastic body 14C like a plate spring may be provided below the receiving member 12 as shown in FIGS. 5A and 5B.

### Preform Producing Apparatus

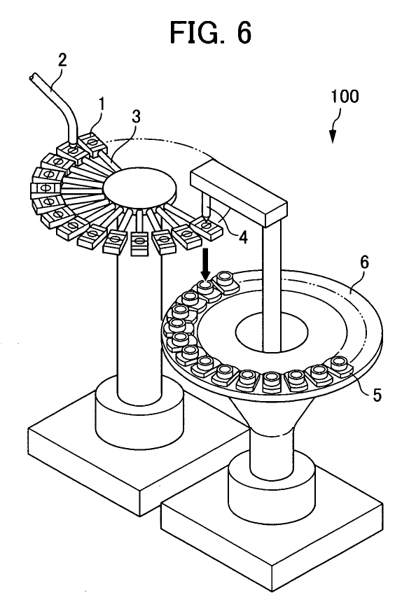

The preform producing apparatus 100 of the invention has the abovementioned molten glass-supporting member 1 as shown in FIG. 6.

The preform producing apparatus 100 of the invention has a discharge nozzle 2 for discharging molten glass from a melting furnace (not shown), a transfer means 3 for transferring the abovementioned molten glass-supporting member 1, and a receiving member-opening means 4 for opening the receiving member 12 of the molten glass-supporting member 1 transferred by the transfer means 3. Furthermore, a plurality of molds 5 is disposed beneath the receiving member-opening means 4 that receive dropped molten glass when the molten glass-supporting member 1 enters to an opened state.

The discharge nozzle 2 is communicated with a melting furnace (not shown) and discharges the molten glass that has been molten by the melting furnace. It is preferred that loge is less than 1.0 at the time when the molten glass is discharged from the discharge nozzle 2 (η: viscosity of molten glass expressed by dPa·s, log: logarithm). It is preferred that the discharge nozzle 2 is provided with a heating device (not shown) from the viewpoint that this state can be easily achieved.

The discharge nozzle 2 may be provided with a sensor, etc. (not shown) to detect time, volume or mass, molten glass of a predetermined volume or mass being discharged per a predetermined time by virtue of the sensor.

A light-emitting portion (not shown) to emit light such as visible light or infrared light and a sensor portion (not shown) to detect light from the light-emitting portion may be provided between the discharge nozzle 2 and the molten glass-supporting member 1 transferred to beneath the discharge nozzle 2, thereby allowing detection of molten glass that is discharged from the discharge nozzle 2.

The preform producing apparatus 100 is provided with a plurality of the molten glass-supporting members 1, and each molten glass-supporting member 1 is held by a transfer means 3. The transfer means 3 transfers each molten glass-supporting member 1 to beneath the discharge nozzle 2 then molten glass is discharged from the nozzle onto the receiving surface 13 in order to receive each molten glass successively discharged from the discharge nozzle 2 on the receiving surface 13. When the molten glass, received by the receiving surface 13, achieves a desired weight, the transfer means 3 transfers the molten glass-supporting member 1 and also transfers another molten glass-supporting member 1 to beneath the discharge nozzle 2 to receive molten glass in sequence.

The molten glass-supporting member 1, which has received molten glass, is transferred to beneath the receiving member-opening means 4 and is pushed open to enter an opened state by action of the receiving member-opening means 4, and molten glass on the receiving surface 13 drops down. Thereafter, the force acting on the receiving member is released by separating the receiving member-opening means 4 from the receiving member or the like, then the receiving member 12 takes a closed state by action of the restoring force of the closed state-maintaining member 12 and is transferred by the transfer means 3 to beneath the discharge nozzle 2 to receive molten glass again on the receiving surface 13.

While the molten glass-supporting member 1 is transferred to beneath the receiving member-opening means 4, the molten glass is cooled to increase its viscosity. It is preferred that logη is no less than 1.0 at the time when the molten glass is dropped down from the molten glass-supporting member 1 (η: viscosity of molten glass expressed by dPa·s, log: logarithm).

When the receiving member 12 is constructed from a porous material, float shaping may also be carried out while transporting the molten glass-supporting member 1. As conditions of the float shaping, for example, processes described in publicly known documents such as Japanese Unexamined Patent Application, First Publication Nos. Hei 06-122526, Hei 08-319124, Hei 08-325021, and 2002-310439 can be used.

The transfer means 3 includes a plurality of arms in order to hold a plurality of molten glass-supporting members 1. The method to hold the molten glass-supporting member 1 is not particularly limited.

The method to transfer the molten glass-supporting member 1 is not particularly limited as long as it is capable of transferring while holding the molten glass-supporting member 1; for example, it can be transferred from beneath the discharge nozzle 2 to beneath the receiving member-opening means 4 by use of a simple action of publicly known robots.

In a case of transferring by use of a pre-programmed robot, for example, the molten glass-supporting members 1 can be freely transferred, and therefore sites to set the discharge nozzle 2 and the receiving member-opening means 4 are not limited and the preform producing apparatus can be downsized. It is also preferred that the molten glass-supporting member 1 is transferred linearly (i.e. reciprocating motion) and/or annularly (circularly in particular) in order to receive molten glass effectively by a plurality of molten glass-supporting members 1 and to repeat the operation to receive molten glass after dropping onto the mold 5.

Furthermore, the transfer means 3 can automatically transfer the molten glass-supporting members 1, which have received molten glass in series, in accordance with a program, thereby making operations to produce performs easy.

The process to hold the molten glass-supporting members 1 is not particularly limited as long as it is capable of holding from beneath the discharge nozzle 2 to beneath the receiving member-opening means 4 without detaching the molten glass-supporting members 1. As conditions of the holding process, for example, processes described in publicly known documents such as Japanese Unexamined Patent Application, First Publication Nos. Hei 01-140738,Hei 02-83182, and Hei 02-82550 can be used.

The molten glass-supporting member 1, which has been transferred from beneath the discharge nozzle 2, is pushed open by the receiving member-opening means 4 to drop the molten glass on the receiving surface 13.

A mold 5 for shaping the molten glass is disposed beneath the receiving member-opening means 4. The position of the mold 5 is adjusted to the site where the molten glass, dropped from the molten glass-supporting member 1, can be received. Thus, the molten glass can be received by the mold 5 only by turning around a rotating table 6 such that the mold 5 takes a predetermined position since the molten glass drops onto the mold by its own weight when the receiving member-opening means 4 merely opens the molten glass-supporting member 1. Consequently, it is unnecessary to separately provide a mechanism for transferring the molten glass to the mold 5, and the preform producing apparatus 100 can be downsized.

While the material, shape, and locating process of the receiving member-opening means 4 are not specifically limited, it is preferred that the tip portion 41 is shaped to be taper-like (rounded shape in particular) in order to efficiently make the receiving portion 12 into an opened state. Furthermore, in cases where the closed state-maintaining member 14 has a magnet such as permanent magnets and electromagnets, the opened state can be achieved by use of a repulsive force by way that the tip portion 41 is also made of a magnet such as permanent magnets and electromagnets. It is preferred in this case that the polarity of the tip portion 41 and the polarity of the members 11a and 11b face oppositely.

When a molten glass body is relatively small, a repulsive force can make the receiving member 12 into an opened state, without contacting the receiving member-opening means 4 and the receiving member 12, by use of magnets at the closed state-maintaining member 14 and the tip portion 41 of the receiving member-opening means 4. Thus, wear can be prevented that is derived from contact between the receiving member 12 and the receiving member-opening means 4, and therefore fine powder dusts generated from wear can be prevented from adhering on molten glass. Furthermore, in cases where the receiving member-opening means 4 and the receiving member 12 contact and when the receiving member 12 has worn, the receiving member-opening means 4 typically must travel an excessively long distance corresponding to the worn loss of the receiving member 12, which may possibly lead to disagreement of motion timing entirely in the preform producing apparatus 100; however, this problem is unlikely to occur in cases where the receiving member-opening means 4 and the receiving member 12 do not contact.

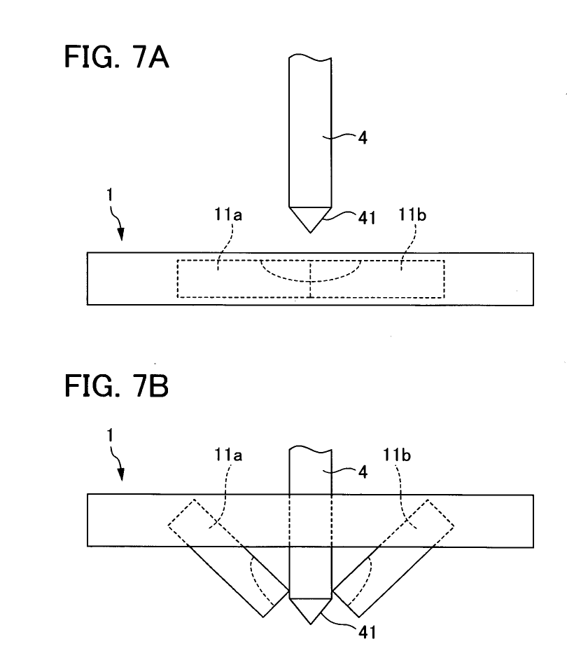

FIGS. 7A and 7B show an appearance in which the receiving member 12 of the molten glass-supporting member turns from a closed state into an opened state by action of the receiving member-opening means 4. Initially, the transfer means 3 transfers the receiving member 12 to beneath the receiving member-opening means 4.

The receiving member-opening means 4 moves toward the receiving member 12 beneath thereof (FIG. 7A), contacts with the receiving member 12 at a site with no contact with the molten glass on the receiving surface 13, then further pushes forward the receiving member 12, thereby causing the receiving member 12 to be in an opened state (FIG. 7B). As a result, the molten glass on the receiving surface 13 drops down, and then is received by the mold 5 moved to beneath the receiving member-opening means 4. In cases where the closed state-maintaining member 14 has a magnet such as permanent magnets and electromagnets and the tip portion 41 also has a magnet such as permanent magnets and electromagnets, the receiving member 12 enters an opened state by action of the magnets to drop the molten glass on the receiving surface 13 only by the receiving member-opening means 4 approaching the receiving member 12.

It may also be difficult to cause the receiving member 12 to be in a closed state by a restoring force when the members 11a and 11b separate to a distance where magnetic flux density weakens. For this reason, the magnets at tip portions of the members 11a and 11b and the magnet at the tip portion 41 of the receiving member-opening means 4 are disposed such that their polarities are opposite at their facing sites, as required, thereby enabling the receiving member 12 to be made into a closed state by use of attracting force of magnets when pulling up the receiving member-opening means 4 after pushing open the receiving member 12 at the tip portion of the receiving member-opening means 4.

The receiving member-opening means 4 is pulled up to the former position after causing the receiving member 12 to be in an opened state and dropping down the molten glass on the receiving surface 13. Then, it makes receiving members 12 transferred in series into an opened state by pushing them open, etc.

The receiving member 12 maintains a closed state by action of a restoring force of the closed state-maintaining member 14 after being pulled up by the receiving member-opening means 4 and also the members 11a and 11b represent a close contact state.

Due to the receiving member-opening means 4 being pushed open, the molten glass that has dropped down is received by the mold 5 that exists beneath the receiving member-opening means 4, and then is shaped.

A plurality of molds 5, disposed on the rotating table 6, moves to beneath the receiving member-opening means 4 by action of rotation of the rotating table 6, and receives the molten glass dropped down from the receiving surface 13. Publicly known various molds are usable for the mold 5.

It is preferred that the molten glass is float-shaped over the mold 5. As conditions of the float shaping, processes described in publicly known documents such as Japanese Unexamined Patent Application, First Publication Nos. Hei 06-122526, Hei 08-319124, Hei 08-325021, and 2002-310439 can be used.

It is also preferred that the same porous material as that of the molten glass-supporting member 1 is used for the mold and that gas is ejected from the pores in order to float-shape the molten glass; for example, the receiving surface of the mold 5 has an inverted cone shape made of a non-porous material, as described in Japanese Unexamined Patent Application, First Publication No. 2003-40632.

The transfer direction may be set for each of the molten glass-supporting members 1. It is also anticipated that operating efficiency considerably increases by way of setting a plurality of receiving member-opening means 4 and the molten glass-supporting members 1 being independently transferred to beneath the receiving member-opening means 4.

### Method of Producing Preform

The method of producing a preform of the invention is carried out using the abovementioned preform producing apparatus. The descriptions of passages that are redundant in content to the abovementioned have been omitted.

Molten glass, molten in a melting furnace (not shown), is discharged from a discharge nozzle 2.

The molten glass, discharged from the discharge nozzle 2, is received by the receiving surface 13 of the molten glass-supporting member 1 that is held by the transfer means 3, and is transferred to beneath the receiving member-opening means 4 by the transfer means 3. During the transfer, the molten glass is cooled by way of gas supplied from a gas supply chamber disposed at the receiving member 12 and ejected from the receiving surface 13, and is float-shaped while increasing its viscosity.

The molten glass on the receiving surface 13 is dropped down by way of the receiving member 12 of the molten glass-supporting member 1, transferred to beneath the receiving member-opening means 4, being pushed open and caused to be in an opened state by the receiving member-opening means 4. Since the mold 5 is disposed beneath the receiving member-opening means 4, the molten glass, transferred to be between the receiving member-opening means 4 and the mold 5, and then dropped down from the molten glass-supporting member 1, is directly received by the mold 5. The mold 5 moves to beneath the receiving member-opening means 4 by appropriately turning the rotating table 6, and receives molten glass dropped down from the molten glass-supporting member 1 in series.

The molten glass on the receiving surface 13 drops down, then the receiving member-opening means 4 is pulled up, and the receiving member 12 undergoes a closing motion by action of a restoring force of the closed state-maintaining member 14 to enter into a closed state. The molten glass-supporting member under the closed state is transferred again to beneath the discharge nozzle 2 by the transfer means 3 and made to receive the molten glass discharged from the discharge nozzle 2.

The molten glass, received by the mold 5, is float-shaped over the mold 5. The shaped preform is then subjected to precision press shaping by a precision press shaping apparatus to produce the intended optical elements.

We claim:

1. A molten glass-supporting member comprising an openable and closable receiving member, of which a receiving surface for receiving molten glass is constructed from a plurality of members, and a closed state-maintaining member for maintaining the receiving member in a closed state.

2. The molten glass-supporting member according to claim 1 further comprising an outer frame outside the receiving member, and the outer frame is provided with a guide means for defining opening and closing orbits of the receiving member.

3. The molten glass-supporting member according to claim 2, the closed state-maintaining member is interposed between the receiving member and the outer frame.

4. The molten glass-supporting member according to claim 1, the closed state-maintaining member is provided inside the receiving member.

5. The molten glass-supporting member according to claim 1, the closed state-maintaining member has an elastic body.

6. The molten glass-supporting member according to claim 1, the closed state-maintaining member has a permanent magnet or an electromagnet.

7. The molten glass-supporting member according to claim 1, the closed state-maintaining member has a portion made of a shape-memory alloy.

8. The molten glass-supporting member according to claim 1, the closed state-maintaining member has a combination of at least two selected from the group consisting of an elastic body, a permanent magnet, an electromagnet and a portion made of a shape-memory alloy.

9. The molten glass-supporting member according to claim 1, the receiving member comes to a close contact state by way of the receiving member performing a closing motion by action of a restoring force of the closed state-maintaining member.

10. A preform producing apparatus includes a molten glass-supporting member according to claim 1,
a discharge nozzle for discharging molten glass onto the receiving surface of the receiving member under a closed state,
a transfer means for transferring the molten glass-supporting member, and
a receiving member-opening means for opening the receiving member of the molten glass-supporting member transferred by the transfer means.

11. The preform producing apparatus according to claim 10, the molten glass discharged from the discharge nozzle is received by the receiving surface, then the transfer means transfers the receiving member-opening means to below the receiving member-opening means, and the receiving member-opening means pushes open the receiving member, thereby making the molten glass on the receiving member drop down.

12. The preform producing apparatus according to claim 10, the molten glass discharged from the discharge nozzle is molded, while increasing viscosity of the molten glass, on the molten glass-supporting member, and loge is no less than 1.0 at the time when the molten glass is dropped down from the receiving member (η: viscosity of molten glass expressed by dPa·s, log: logarithm).

13. The preform producing apparatus according to claim 10, logη is less than 1.0 at the time when the molten glass is discharged from the discharge nozzle (η: viscosity of molten glass expressed by dPa·s, log: logarithm).

14. The preform producing apparatus according to claim 10, a mold is provided below the receiving member-opening means, and the molten glass dropped down by way of opening the receiving member is received by the mold.

15. The preform producing apparatus according claim 10, the receiving member-opening means has a taper-shaped tip portion that faces the receiving member.

16. The preform producing apparatus according to claim 10, the transfer means transfers the molten glass-supporting member linearly and/or annularly.

17. The preform producing apparatus according to claim 10, the closed state-maintaining member has a permanent magnet or an electromagnet, and a tip portion facing the receiving member, in the receiving member-opening means, has a permanent magnet or an electromagnet.

18. The preform producing apparatus according to claim 10, the receiving member comes to a close contact state by way of the receiving member performing a closing motion by action of a restoring force of the closed state-maintaining member after opening the receiving member by the receiving member-opening means.

19. A method of producing a preform using the preform producing apparatus according to claim 10.
